(19) United States
(12) Patent Application Publication
(10) Pub. No.: US 2010/0176772 A1
(43) Pub. Date: Jul. 15, 2010

(54) MULTIPHSE DC/DC CONVERTER

(76) Inventors: Arthur Schaefert, Buehlertal (DE); Boris Blaumeiser, Zuerich (CH)

Correspondence Address: KENYON & KENYON LLP, ONE BROADWAY, NEW YORK, NY, 10004, US

(21) Appl. No.: 12/451,325

(22) PCT Filed: May 19, 2008
(86) PCT No.: PCT/EP2008/056113

§ 371 Date: Mar. 19, 2010

(30) Foreign Application Priority Data
May 31, 2007 (DE) 102007025229.5

(51) Int. Cl. G05F 1/10

(52) U.S. Cl. 323/234

(57) ABSTRACT

A multiphase DC/DC converter has multiple converter cells that are arranged in parallel to one another and clocked in a time-staggered manner. Equipped on the input side and/or output side of the converter cells is a voltage sensor or a current sensor. The latter is connected via an analog-digital converter to a separator, which is provided for separating the output signal of the analog-digital converter into voltage or current values associated with the individual phases of the converter. The separator is connected to a control system, which on the output side provides control signals influencing the clock signals of the converter cells.

### BACKGROUND OF THE INVENTION

1. Field of the Invention

The present invention relates to a multiphase DC/DC converter.

2. Description of Related Art

Published German patent document DE 101 10 615 A1 describes a method for producing control impulses for power semiconductors, in particular for the purpose of generating offset control impulses for half-bridges, which are taken up on multiphase converters or DC/DC converters. In this method, the reference voltage is shifted by a delay time corresponding to the offsets or a PWM signal is shifted by a delay time corresponding to the duration of the period divided by the number of offsets.

Published German patent document DE 101 19 985 A1 describes a device for supplying power to a multi-voltage on-board electrical system of a motor vehicle. This device has a multi-voltage on-board electrical system situated in a motor vehicle, which provides at least one first and one second voltage level, in each case differing from the reference potential. The multi-voltage on-board electrical system is powered from at least one electrical energy store. It furthermore has at least one converter for connecting the two voltage levels. Furthermore, supply means are provided for externally supplying power to the multi-voltage on-board electrical system. The mentioned converter may be implemented in the form of a multiphase converter. In such converters, several converter cells of lower capacity are connected in parallel, and the power circuits are clocked in a time-staggered manner. This saves filter components on account of the effects of destructive interference. Such multiphase converters make it possible to implement the first and second converters using the available phases of a single multiphase converter. To this end, the phases are divided up into converters having the function of a step-down and step-up transformer. The phases are then separated inside the converter, on the input side, via a switch.

In future on-board power systems of motor vehicles, powerful DC/DC converters are required in order to be able to control the flow of power between different voltage levels. Due to limitations in terms of costs, space, and weight, such a use in the motor vehicle field requires minimizing the inductors and capacitors as well as the number of components as a whole. These limitations may be satisfied by using multiphase DC/DC converters as DC/DC converters. In these the power to be transmitted is distributed to multiple converter cells. If one implements a time-staggered clocking of the converter cells in connection with this principle, then the current ripples in the superimposed output signal partly cancel one another or are reduced by a substantial amount. The frequency of the output signal of the DC/DC converter rises by the number of converter cells clocked in time-staggered fashion with respect to the base clock frequency of the converter cells. Because of the smaller ripples and the higher frequency, the output filters of the DC/DC converter may be designed smaller. An advantage in terms of cost and space is thus achieved.

To use this method efficiently, a current sensor must be used for each converter cell in order to be able to monitor and control the associated current ripples. Without such an individual phase control, the ripples per phase may be of different magnitude on account of component tolerances, as a result of which the previously mentioned advantage in the superimposition of the output signals of the converter cells is no longer effective. The ripples in the output signal increase in magnitude and the frequency of the output signal again assumes the same value as the switching frequency of the individual converter cells. The previously mentioned advantages are thereby cancelled out.

### BRIEF SUMMARY OF THE INVENTION

By contrast, a multiphase DC/DC converter according to the present invention has the advantage that the number of its current sensors is reduced. This reduces the costs of a multiphase DC/DC converter substantially. In addition, space is saved and the weight of a multiphase DC/DC converter is reduced. This favors the use of a multiphase DC/DC converter in the on-board power system of a motor vehicle.

The aforementioned advantages are achieved in that the converter cells, which are arranged in parallel to each other and clocked in a time-staggered manner, are connected to a voltage sensor on the input side and/or on the output side, which is connected via an analog-digital converter to a separator, which is provided for separating the output signal of the analog-digital converter into voltage values associated with the individual converter cells of the multiphase DC/DC converter. The separator in turn is connected to a control system that provides control signals on its output side, by which the clock signals of the converter cells are influenced or controlled in such a way that the voltage values associated with the various converter cells coincide. This has the consequence that the voltage ripples of the individual converter cells cancel one another out and that the frequency of the output signal of the voltage converter increases by the number of phases or converter cells clocked in an offset manner with respect to the base clock frequency of the converter cells. Due to the smaller ripples and the higher frequency, the output filter of the multiphase DC/DC converter may be designed smaller, which yields another advantage in terms of costs and space.

A multiphase DC/DC converter according to the present invention preferably has a separator, which contains multiple time-triggered separator units arranged in parallel to one another, each of which is associated with one of the converter cells. By this measure it is possible to ensure that while switching on a converter cell—or, depending on the pulse control factor, also while switching off a converter cell—the voltage level measured during this time on the output of the analog-digital converter may be directly allocated to this converter cell. In this manner it is possible to obtain from the output signal of the analog-digital converter for each converter cell an associated voltage level, which is used to influence the clock signal of the respective converter cell.

The trigger signal required for triggering the separator units is advantageously derived from the output signal of a PWM generator, which is associated with the respective converter cell and provides the clock signal for this converter cell. The clocking of a converter cell and the triggering of the associated separator unit may consequently be performed advantageously on the basis of a single signal, which is provided by a PWM generator.

The control system connected to the separator preferably has several controllers arranged in parallel to one another, each of which is associated with one of the converter cells, the input of each controller being connected to the output of the respectively associated separator unit. Thus a control signal may be readily provided for each converter cell, which influences the clock signal of the associated converter cell in the desired manner.

Advantageously, the output of the controllers is respectively connected via an adder to the associated PWM signal generator. In this adder, the control signal provided by the associated controller and an additional control signal derived from an additional controller are superimposed. This additional controller is connected to a current setpoint value generator and via an additional analog-digital converter to a current sensor, which is positioned between the output of the converter cells and an output filter.

Consequently, an essential advantage of the present invention is that, irrespective of the number of its converter cells or phases, a multiphase DC/DC converter requires only a single current sensor situated on the output side of the converter cells. Nevertheless, because of the use of a voltage sensor provided on the input side and/or on the output side of the converter cells, from the output signal of which voltage values or voltage levels associated with the individual phases of the converter are separated out by a separator, it is possible to readjust each converter cell individually such that ripples formed for example due to component tolerances are reduced or mutually cancelled out.

### BRIEF DESCRIPTION OF THE SEVERAL VIEWS OF THE DRAWING

FIG. 1 shows a block diagram of a multiphase DC/DC converter according to the present invention.

FIG. 2 shows a circuit diagram displaying the fundamental structure of the converter cells of a multiphase DC/DC converter.

### DETAILED DESCRIPTION OF THE INVENTION

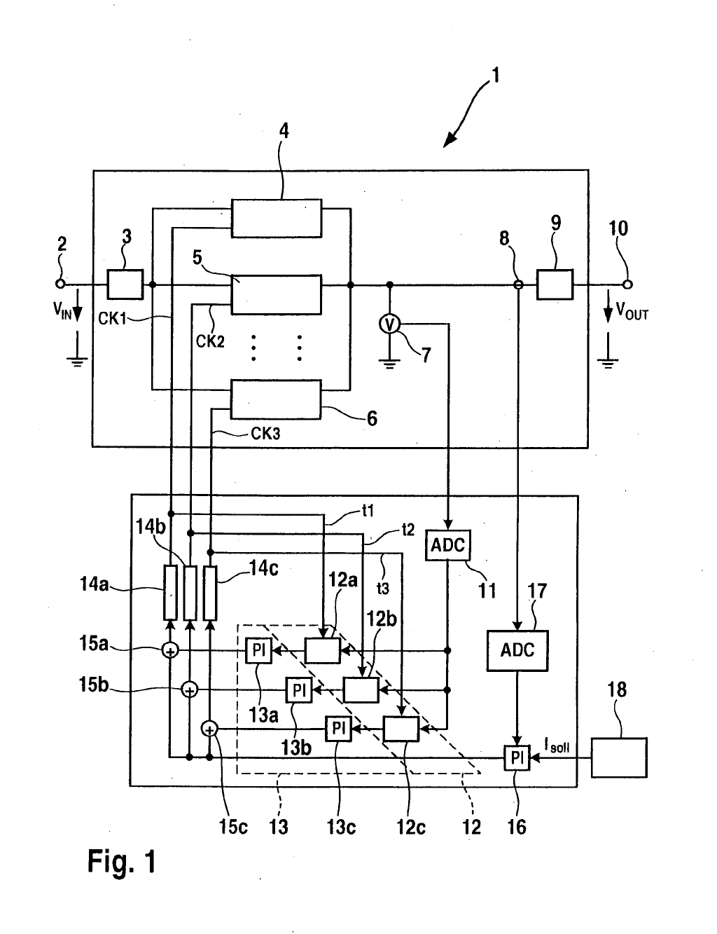

FIG. 1 shows a block diagram of a multiphase DC/DC converter 1 according to the present invention. It has an input terminal 2, on which the input voltage V_{IN} of the converter is applied. It amounts to 14 volts for example. The task of the converter is to convert this input voltage into an output voltage measuring 42 volts for example. This output voltage V_{OUT} of the converter is provided on an output terminal 10.

The multiphase DC/DC converter represented in FIG. 1 has an input filter 3 connected to input terminal 2, which is a low-pass filter that filters interferences in the input voltage. The output of input filter 3 is connected to a parallel circuit of several converter cells 4, 5, 6, the number of these converter cells connected in parallel to one another depending on the respective application.

The outputs of converter cells 4, 5, 6 are brought together again and are connected to output terminal 10 via a current sensor 8 and an output filter 9. Furthermore, a voltage sensor 7 is provided between the outputs of converter cells 4, 5, 6 and ground. Output filter 9 is also a low-pass filter for example.

The output signal of voltage sensor 7 is converted into a digital signal in an analog-digital converter 11. This digital signal present on the output of analog-digital converter 11 is transmitted to a separator 12. The latter in turn is connected to a control system 13, which provides control signals on its outputs by which the clock signals CK1, CK2, CK3 of converter cells 4, 5, 6 are influenced.

Separator 12 has three separator units 12a, 12b, 12c connected in parallel to one another, the inputs of which are respectively connected to the output of analog-digital converter 11. Separator unit 12a has the task of separating a voltage level associated with converter cell 4 from the output signal of analog-digital converter 11. To this end, the trigger input of separator unit 12a is supplied with a trigger signal t1, which is derived from the clock signal CK1 of converter cell 4 and agrees with the latter in the shown exemplary embodiment. Separator unit 12b has the task of separating a voltage level associated with converter cell 5 from the output signal of analog-digital converter 11. To this end, the trigger input of separator unit 12b is supplied with a trigger signal 12, which is derived from the clock signal CK2 of converter cell 5 and agrees with the latter in the shown exemplary embodiment. Separator unit 12c has the task of separating a voltage level associated with converter cell 6 from the output signal of analog-digital converter 11. To this end, the trigger input of separator unit 12c is supplied with a trigger signal T3, which is derived from the clock signal CK3 of converter cell 6 and agrees with the latter in the shown exemplary embodiment.

In a voltage controller 13a of control system 13, the voltage level provided on the output of separator unit 12a is converted into a control signal associated with converter cell 4. In an adder 15a, this control signal has superimposed on it the control signal of an additional controller 16, which is a current controller. Current controller 16 is supplied on the input side with a current setpoint value I_{SOLL} provided by a current setpoint value generator 18 and a current value signal derived from current sensor 8 and transmitted via another analog-digital converter 17. In a PWM generator 14a, the output signal of adder 15a is converted into a PWM signal, which is the clock signal CK1 of converter cell 4.

In a voltage controller 13b of control system 13, the voltage level provided on the output of separator unit 12b is converted into a control signal associated with converter cell 5. In an adder 15b, this control signal also has the control signal of current controller 16 superimposed on it. In a PWM generator 14b, the output signal of adder 15b is converted into a PWM signal, which is the clock signal CK2 of converter cell 5.

In a voltage controller 13c of control system 13, the voltage level provided on the output of separator unit 12c is converted into a control signal associated with converter cell 6. In an adder 15c, this control signal also has the control signal of current controller 16 superimposed on it. In a PWM generator 14c, the output signal of adder 15c is converted into a PWM signal, which is the clock signal CK3 of converter cell 6.

As can be seen from the above explanations, a multiphase DC/DC converter according to the present invention does not require an individual phase current measurement using a plurality of current sensors. Only one single current sensor 8 is used, which is positioned between the outputs of the converter cells and the output filter. Furthermore, a voltage sensor 7 is provided, which is likewise positioned between the outputs of the converter cells and the output filter and the output signal of which is transmitted via an analog-digital converter 11 to a separator 12. Using a suitable triggering, the latter separates the output signal of the analog-digital converter into voltage values associated with the individual phases of the converter or the individual converter cells. In a control system 13, these voltage values are converted into control signals, which influence the clock signals CK1, CK2, CK3 of the converter cells.

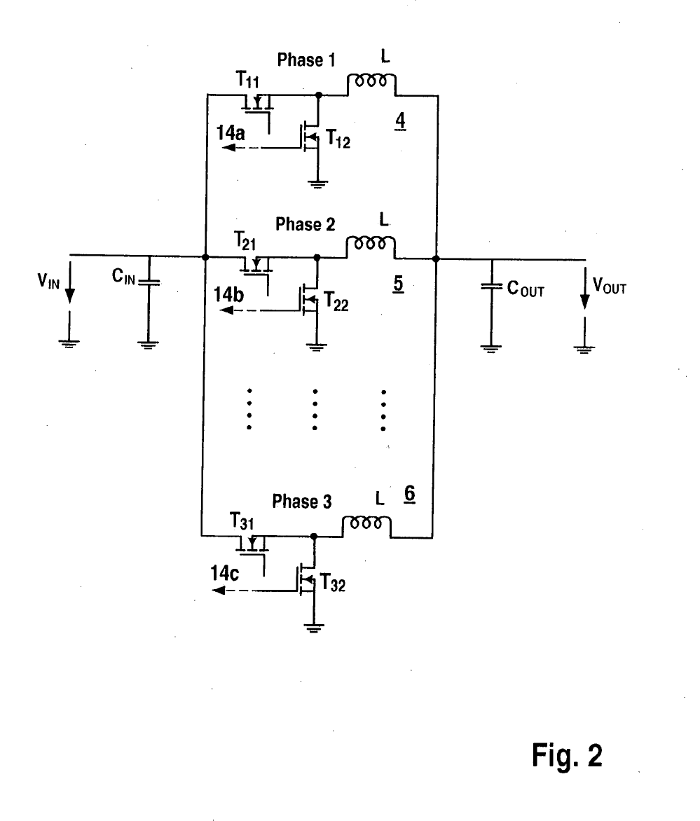

FIG. 2 shows a circuit diagram displaying the fundamental structure of the converter cells of a multiphase DC/DC converter. This circuit diagram reveals that the input voltage V_{IN} present on the input terminal is applied to a parallel circuit of n converter cells, three converter cells in the exemplary embodiment shown, via a low-pass filter, which has for example a capacitor C_{IN} connected to ground. These converter cells are clocked in a time-staggered manner.

Converter cell 4 is associated with a phase 1, converter cell 5 with a phase 2 and converter cell 6 with a phase 3. Converter cell 4 has a transistor T₁₁ connected to the input of the parallel circuit, a transistor T₁₂ connected to the output of PWM generator 14a, and a coil L. One terminal of coil L is connected to the connection point between the two transistors T₁₁ and T₁₂. The other terminal of coil L is connected to the output of the parallel circuit. Converter cell 5 has a transistor T₂₁ connected to the input of the parallel circuit, a transistor T₂₂ connected to the output of PWM generator 14b, and a coil L. One terminal of coil L is connected to the connection point between the two transistors T₂₁ and T₂₂. The other terminal of coil L is connected to the output of the parallel circuit. Converter cell 6 has a transistor T₃₁ connected to the input of the parallel circuit, a transistor T₃₂ connected to the output of PWM generator 14c, and a coil L. One terminal of coil L is connected to the connection point between the two transistors T₃₁ and T₃₂. The other terminal of coil L is connected to the output of the parallel circuit.

The output of the parallel circuit is connected to the output terminal V_{OUT} of the multiphase DC/DC converter via an output filter, which has a capacitor C_{OUT} connected to ground.

As a result of the described time-staggered clocking of transistors T₁₂, T₂₂ and T₃₂, the converter cells of the multiphase DC/DC converter are activated at different times. During these times—as was explained in connection with FIG. 1—the associated voltage level on the output of the converter is detected using a voltage sensor, an analog-digital converter, and a separator. This current level, which is individually allocated to the respective converter cell, is converted in a controller into a control signal, which is used to influence the clock signal for the respective converter cell.

An alternative example embodiment provides for a current sensor to be situated also on the input of the converter cells, in addition to the current sensor situated on the output of the converter cells, in order to control the input current of the converter as well.

Another alternative is to implement a bidirectional multiphase DC/DC converter. It provides respectively one voltage sensor and one current sensor both on the input side as well as on the output side of the converter cells, the output signal of the voltage sensor being evaluated respectively via one analog-digital converter and one separator.

The components 11, 12, 13, 14a, 14b, 14c, 15a, 15b, 15c, 16 and 17 shown in FIG. 1 may be implemented in the form of a discrete circuit or in the form of a processor.

In the exemplary embodiment described above, an input voltage of 14 V is converted by the DC/DC converter into an output voltage of 42 V. The present invention is not limited to this exemplary embodiment however. The input voltage and the output voltage may also have different values. In particular, the input voltage may also be greater than the output voltage.

Furthermore, a multiphase DC/DC converter according to the present invention may also be a bidirectional step-up/step-down converter having four transistors per converter cell. In this case, one voltage sensor and one current sensor are used per terminal side of the converter cells.

Furthermore, in the exemplary embodiment described above, the output signal of a voltage sensor 7 was transmitted via an analog-digital converter 11 to a separator 12. Alternatively, a current sensor may also be used as a signal source for the separator.

1-10. (canceled)

11. A multiphase DC/DC converter, comprising:
multiple converter cells arranged in parallel to one another and clocked in a time-staggered manner;
one of a first voltage sensor or a current sensor provide on at least one of an input side and output side of the multiple converter cells;
a separator;
a first analog-digital converter connecting the one of the voltage sensor or the current sensor to the separator, wherein the separator is configured to separate the output signal of the analog-digital converter into one of voltage values or current values associated with individual phases of the converter; and
a control system connected to the separator, wherein the control system outputs control signals influencing clock signals of the multiple converter cells.

12. The multiphase DC/DC converter as recited in claim 11, wherein the separator has multiple time-triggered separator units arranged in parallel to one another and correspondingly associated with the multiple converter cells.

13. The multiphase DC/DC converter as recited in claim 12, wherein a trigger input of each time-triggered separator unit is respectively connected to an output of a corresponding PWM signal generator allocated to an associated converter cell.

14. The multiphase DC/DC converter as recited in claim 13, wherein the control system includes multiple controllers arranged in parallel to one another and correspondingly associated with the multiple converter cells, and wherein the input of each controller is connected to the output of the respectively associated time-triggered separator unit.

15. The multiphase DC/DC converter as recited in claim 14, wherein the output of each controller is respectively connected by a corresponding adder to the associated PWM signal generator.

16. The multiphase DC/DC converter as recited in claim 15, wherein the adders associated with the multiple controllers are respectively connected to the same output of another control unit.

17. The multiphase DC/DC converter as recited in claim 16, wherein the additional control unit is one of a current controller or a voltage controller, and wherein a first input of the additional control unit is connected to a setpoint value generator.

18. The multiphase DC/DC converter as recited in claim 17, wherein a second input of the additional control unit is connected by an additional analog-digital converter to one of a current sensor or a voltage sensor situated between the output of the converter cells and an output terminal of the multiphase DC/DC converter.

19. The multiphase DC/DC converter as recited in claim 14, further comprising:
one of an additional current sensor or voltage sensor situated between an input terminal of the multiphase DC/DC converter and the input of the converter cells.

20. The multiphase DC/DC converter as recited in claim 14, wherein the multiphase DC/DC converter is a bidirectional multiphase DC/DC converter and has one of a second voltage sensor or current sensor situated on the side of the converter cells opposite from the one of the first voltage sensor or current sensor.
